(19) United States
(12) Patent Application Publication
(10) Pub. No.: US 2013/0195513 A1
(43) Pub. Date: Aug. 1, 2013

(54) DEVELOPING DEVICE AND IMAGE FORMING APPARATUS

(71) Applicant: FUJI XEROX CO., LTD., Tokyo (JP)

(72) Inventor: Taiyou UEHARA, Kanagawa (JP)

(73) Assignee: FUJI XEROX CO., LTD., Tokyo (JP)

(21) Appl. No.: 13/654,968

(22) Filed: Oct. 18, 2012

(30) Foreign Application Priority Data
Jan. 26, 2012 (JP) 2012-013945

(51) Int. Cl. G03G 15/09

(52) U.S. Cl. 399/269; 399/274

(57) ABSTRACT

A developing device includes a first developer transporting member, a first magnet member, a second developer transporting member, a second magnet member, and a passage regulating member. Among magnetic poles of the first magnet member and magnetic poles of the second magnet member, the magnetic poles having different magnetic properties that are disposed closest to each other and that oppose each other are disposed in an area that is opposite an area at whose side a latent image carrying member exists with a virtual straight line being a boundary thereof, the virtual straight connecting a center position of the first magnet member corresponding to a center of rotation of the first developer transporting member and a center position of the second magnet member corresponding to a center of rotation of the second developer transporting member with each other.

### CROSS-REFERENCE TO RELATED APPLICATIONS

This application is based on and claims priority under 35 USC 119 from Japanese Patent Application No. 2012-013945 filed Jan. 26, 2012.

### BACKGROUND

(i) Technical Field

The present invention relates to a developing device and an image forming apparatus.

(ii) Related Art

Image forming apparatuses, such as image recording printers (including electrophotographic printers and electrostatic recording printers), copying machines, and facsimiles are provided with developing devices that develop electrostatic latent images, formed on latent image carrying members (such as photoconductor members), with developer.

Among such developing devices, there is provided a developing device of a type that increases development efficiency as a result of disposing more than one developing roller (such as two developing rollers) that carries a magnetic developer by magnetic force and rotates to a development area where it opposes a latent image carrying member, to transport the developer. Here, “magnetic developer” refers to, for example, a two-component developer containing non-magnetic toner and magnetic carriers, or a magnetic one-component developer. “Developing roller” refers to, for example, a developer carrying transporting member including a circular cylindrical transporter that rotates and a magnetic member that is disposed in a fixed to an inner side of the transporting member and that generates magnetic lines of force for carrying the developer on an outer peripheral surface of the transporting member by magnetic force.

### SUMMARY

According to an aspect of the invention, there is provided a developing device including a first developer transporting member that has a circular cylindrical shape, the first developer transporting member being provided so as to rotate with the first developer transporting member being spaced apart by a required interval from an outer peripheral surface of a latent image carrying member that rotates, the first developer transporting member having an outer peripheral surface that transports a magnetic developer; a first magnet member that is provided in a fixed state in an internal space of the first developer transporting member, the first magnet member including magnetic poles that extend along an axial direction of the first developer transporting member and that are disposed so as to be spaced apart from each other in a direction of rotation of the first developer transporting member; a second developer transporting member that has a circular cylindrical shape, the second developer transporting member being provided so as to rotate with the second developer transporting member being spaced apart by a required interval from a portion of the outer peripheral surface of the latent image carrying member that is situated downstream from the first developer transporting member in a direction of rotation of the latent image carrying member and with the second developer transporting member being spaced apart by a required interval from the outer peripheral surface of the first developer transporting member, the second developer transporting member having an outer peripheral surface that transports a magnetic developer; a second magnet member that is provided in a fixed state in an internal space of the second developer transporting member, the second magnet member including magnetic poles that extend along an axial direction of the second developer transporting member and that are disposed so as to be spaced apart from each other in a direction of rotation of the second developer transporting member; and a passage regulating member that is provided with the passage regulating member opposing the outer peripheral surface of one of the first developer transporting member and the second developer transporting member along the axial direction of the one of the first developer transporting member and the second developer transporting member and with the passage regulating member being spaced apart by a required interval from the outer peripheral surface of the one of the first developer transporting member and the second developer transporting member, the passage regulating member regulating passage of a portion of the developer supplied to the outer peripheral surface of the one of the first developer transporting member and the second developer transporting member, and maintaining a required transport amount. Among the magnetic poles of the first magnet member and the magnetic poles of the second magnet member, the magnetic poles having different magnetic properties that are disposed closest to each other and that oppose each other are disposed in an area that is opposite an area at whose side the latent image carrying member exists with a virtual straight line being a boundary thereof, the virtual straight connecting a center position of the first magnet member corresponding to a center of rotation of the first developer transporting member and a center position of the second magnet member corresponding to a center of rotation of the second developer transporting member with each other.

### BRIEF DESCRIPTION OF THE DRAWINGS

Exemplary embodiments of the present invention will be described in detail based on the following figures, wherein:

FIG. 1 illustrates an image forming apparatus using developer devices according to a first exemplary embodiment of the present invention;

FIG. 2 is a partial sectional explanatory view of principal portions (such as image forming devices) in the image forming apparatus shown in FIG. 1;

FIG. 3 is a schematic sectional view of a developing device used in the image forming apparatus shown in FIG. 1;

FIGS. 4A and 4B are each a schematic explanatory view of principal portions (such as a developing roller) of the developing device shown in FIG. 3, with FIG. 4A being an explanatory view of a first developing roller and structural components in the vicinity thereof, and FIG. 4B being an explanatory view of a second developing roller and structural components in the vicinity thereof;

FIG. 5 is an explanatory sectional view of the principal portions of the developing device shown in FIG. 3 (such as the arrangement of magnetic poles of magnet rollers of the developing rollers);

FIG. 6 is an explanatory view of the basic operation of the developing device shown in FIGS. 3 and 5;

FIG. 7 is an enlarged explanatory view illustrating operational effects of the principal portions of the developing device shown in FIG. 6;

FIG. 8 is an explanatory view of another exemplary structure (a modification of the arrangement of magnetic poles of the magnet rollers) in the developing device according to the first exemplary embodiment;

FIG. 9 is an explanatory sectional view of a developing device according to a second exemplary embodiment of the present invention;

FIG. 10 is an explanatory view of the basic operation of the developing device shown in FIG. 9;

FIG. 11 is an explanatory sectional view of an existing developing device;

FIGS. 12A and 12B are each an explanatory schematic view of, for example, principal portions (such as a developing roller) of the developing device shown in FIG. 11, with FIG. 12A being an explanatory view of a first developing roller and structural components in the vicinity thereof, and FIG. 12B being an explanatory view of a second developing roller and structural components in the vicinity thereof; and

FIG. 13 is an enlarged explanatory view illustrating problematic phenomena and operational effects of the principal portions of the developing device shown in FIG. 11.

### DETAILED DESCRIPTION

Exemplary embodiments of the present invention will hereunder be described with reference to the drawings.

### First Exemplary Embodiment

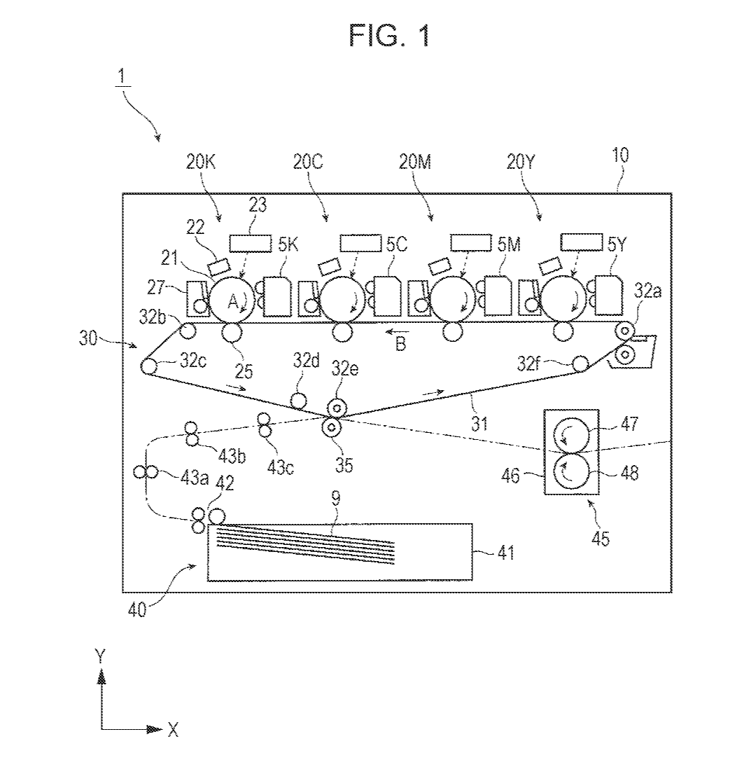

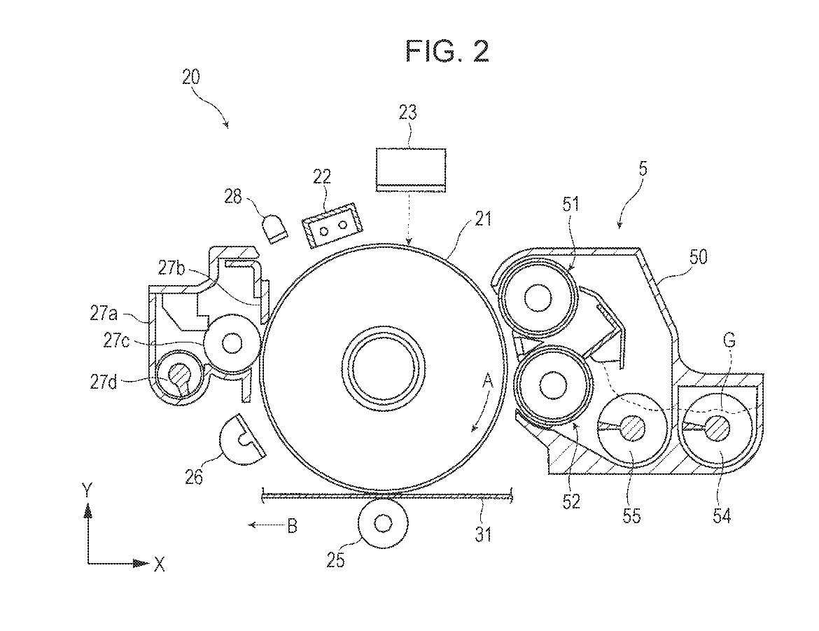

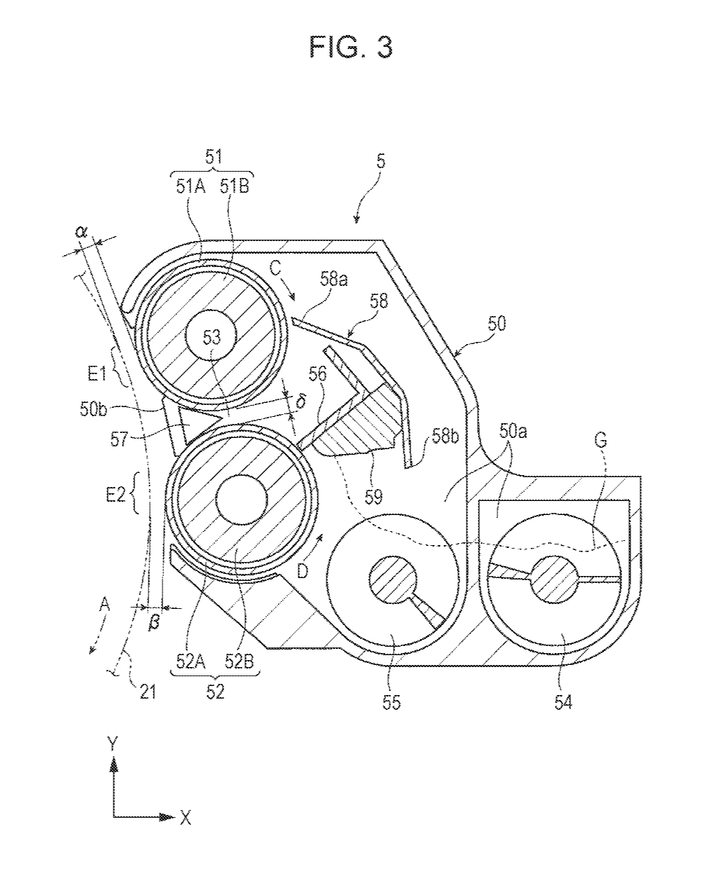

FIGS. 1 to 3 each illustrate an image forming apparatus 1 using developing devices according to a first exemplary embodiment of the present invention. FIG. 1 schematically illustrates the image forming apparatus 1. FIG. 2 illustrates principal portions (image forming devices including developing devices) in the image forming apparatus 1. FIG. 3 illustrates each developing device.

The image forming apparatus 1 is formed as, for example, a color printer. The image forming apparatus 1 includes, for example, image forming devices 20, an intermediate transfer device 30, a sheet feeding device 40, and a fixing device 45 in an internal space of a housing 10. Each image forming device 20 forms a toner image developed with toner (fine powder that is, for example, colored) forming developer. The intermediate transfer device 30 carries the toner images, formed at the respective image forming devices 20, and finally second-transfers the toner images to recording paper 9 serving as an exemplary recording material. The sheet feeding device 40 holds and transports required pieces of recording paper 9 to be supplied to a second transfer section of the intermediate transfer device 30. The fixing device 45 fixes the toner images by allowing the recording paper 9 to which the toner images have been transferred by the intermediate transfer device 30 to pass therethrough. At the housing 10, a supporting structure and an exterior portion are formed by, for example, a supporting member and an outer covering. An alternate long and short dash line in FIG. 1 indicates a principal transport path along which pieces of recording paper 9 are transported in the housing 1.

The image forming devices 20 correspond to four image forming devices 20Y, 20M, 20C, and 20K that specially form toner images of four colors, yellow (Y), magenta (M), cyan (C), and black (K), respectively. The four image forming devices 20Y, 20M, 20C, and 20K are disposed side by side in series in the internal space in the housing 10. The image forming devices 20Y, 20M, 20C, and 20K have substantially the same structure as described below, except that they handle different types of developer.

As shown in FIGS. 1 and 2, each image forming device 20Y, 20M, 20C, and 20K includes a photoconductor drum 21 that rotates, with each of the following devices being principally disposed around the photoconductor drum 21. The principal devices include, for example, charging devices 22, exposing devices 23, developing devices 5Y, 5M, 5C, and 5K, first transfer devices 25, prior-to-cleaning charging devices 26, drum cleaning devices 27, and electricity removing devices 28. Each charging device 22 charges to a required potential an image carrying surface (outer peripheral surface) of the associated photoconductor drum 21 on which an image is capable of being formed. The exposing devices 23 form electrostatic latent images (for the corresponding colors) having a potential difference on the charged outer peripheral surfaces of the respective photoconductor drums 21 by irradiating the charged outer peripheral surfaces with light based on image information (signal). The developing devices 5Y, 5M, 5C, and 5K develop the electrostatic latent images with toners of developers of the corresponding colors (Y, M, C, K) to form toner images. Each first transfer device 25 transfers the toner image to an intermediate transfer belt of the intermediate transfer device 30. The prior-to-cleaning charging devices 26 charge extraneous matter, such as toner, that remains and is stuck on the image carrying surfaces of the respective photoconductor drums 21 after the first transfer. Each drum cleaning device 27 removes and cleans off any recharged extraneous matter. The electricity removing devices 28 remove electricity from the image carrying surfaces of the cleaned photoconductor drums 21.

Each photoconductor drum 21 includes the image carrying surface including a photoconductive layer (photosensitive layer), formed of a photosensitive material, on a peripheral surface of a circular cylindrical or a columnar cylindrical base that is connected to ground. Each photoconductor drum 21 is supported so as to rotate in the direction of arrow A as a result of receiving power from a rotation driving device (not shown). Each charging device 22 is a non-contact charging device (such as a corona discharge device) disposed so as not to be in contact with the photoconductor drum 21, or a contact charging device that uses, for example, a charging roller to which charging voltage is supplied and that is disposed in contact with the photoconductor drum 21. If the developing devices 5 are those that perform reversal development, as charging voltage or current, a voltage or a current having a polarity that is the same as the charging polarity of the toner supplied from each developing device is supplied.

Each exposing device 23 irradiates the image carrying surface of the charged photoconductor drum 21 with light (indicated by a dotted arrow) that is formed in accordance with image information that is input to the image forming apparatus 1, to form an electrostatic latent image. Image signals of the corresponding color components, obtained after performing required image processing operations on the image information (serving as a print object that is input to the image forming apparatus 1) by an image processing device, are transmitted to the exposing devices 23. The developing devices 5Y, 5M, 5C, and 5K use, for example, two-component developers containing magnetic carriers and nonmagnetic toners of the four colors. As shown, in particular, in, for example, FIGS. 2 and 3, each developing device 5 includes two developing rollers, that is, a developing roller 51 and a developing roller 52. Each developing device 5 will be described in detail later.

Each first transfer device 25 is a contact transfer device including a first transfer roller that rotates while contacting the image carrying surface of the associated photoconductor drum 21 and to which a first transfer voltage is supplied. As the first transfer voltage, for example, a direct-current voltage having a polarity that is opposite to the toner charging polarity is applied from a transfer power supply (not shown). Each first transfer device 25 may be thought of as constituting the intermediate transfer device 30. As shown in FIG. 2, each drum cleaning device 27 includes, for example, a container body 27a, a cleaning plate (cleaning blade) 27b, a rotating brush roller 27c, and a sending-out member 27d. A portion of each body 27a is open. Each cleaning plate 27b is disposed so as to contact the outer peripheral surface of the photoconductor drum 21 after the first transfer with a required pressure, and removes extraneous matter such as residual toner. Each rotating brush roller 27c is disposed so as to rotate while contacting a portion of the outer peripheral surface of the photoconductor drum situated upstream from the cleaning plate 27b in the direction of rotation of the photoconductor drum 21, and cleans the outer peripheral surface of the photoconductor drum 21. Each sending-out member 27d, such as a screw auger, is driven so that any extraneous matter, such as toner, removed by the cleaning plate 27b is collected and sent to a collecting system (not shown). As each cleaning plate 27b, a plate member formed of, for example, rubber is used.

As shown in FIG. 1, the intermediate transfer device 30 is disposed so as to exist at a lower side of each of the image forming devices 20Y, 20M, 20C, and 20K. The intermediate transfer device 30 primarily includes an intermediate transfer belt 31, support rollers 32a to 32f, a second transfer device 35, and a belt cleaning device 36. The intermediate transfer belt 31 rotates in the direction of arrow B while passing first transfer positions that are situated between the photoconductor drums 21 and the first transfer devices 25 (first transfer rollers), respectively. The support rollers 32a to 32f rotatably support the intermediate transfer belt 31 while holding the intermediate transfer belt 31 from an inner surface thereof. The second transfer device 35 rotates while contacting with a predetermined pressure the outer peripheral surface (image carrying surface) of the intermediate transfer belt 31 that is supported by the support roller 32e. The belt cleaning device 36 removes and cleans off any extraneous matter, such as toner or paper powder, remaining and stuck on the outer peripheral surface of the intermediate transfer belt 31 after a portion of the outer peripheral surface of the intermediate transfer belt 31 has passed the second transfer device 35.

As the intermediate transfer belt 31, for example, an endless belt is used. In the endless belt, for example, resin particles formed of polytetrafluoroethylene (PTFE) for the purpose of providing separability with respect to the toner images are dispersed in a belt base material. In the belt base material, a resistance regulating agent, such as carbon black, is dispersed in synthetic resin, such as polyimide resin or polyamide resin. The support roller 32a is formed as a driving roller. The support rollers 32b, 32d, and 32f are formed as driven rollers that maintain, for example, a belt running position. The support roller 32c is formed as a tension applying roller. The support roller 32e is formed as a second-transfer backup roller.

The second transfer device 35 includes a second transfer roller and a second-transfer power supply (not shown). The second transfer roller contacts with a required pressure a portion of the outer peripheral surface of the intermediate transfer belt 31 that is supported by the backup roller 32e. The second-transfer power supply (not shown) supplies a second transfer voltage to the backup roller 32e or the second transfer roller (35). As the second transfer voltage, for example, a direct-current voltage having a polarity that is the same as (or that is opposite to) the toner charging polarity is supplied. The belt cleaning device 36 includes, for example, a cleaning plate (cleaning blade) 36a and a rotating brush 36b. The cleaning plate 36a is disposed so as to contact with a required pressure a portion of the outer peripheral surface of the intermediate transfer belt 31 that has passed the second transfer device 35, and removes any extraneous matter, such as residual toner. The rotating brush 36b contacts a portion of the outer peripheral surface of the intermediate transfer belt 31 that is situated upstream from the cleaning plate 36a in the direction of rotation of the belt, and cleans the outer peripheral surface of the intermediate transfer belt 31. As the cleaning plate 36a, a plate member formed of, for example, rubber is used.

The sheet feeding device 40 is disposed so as to exist below the intermediate transfer device 30. The sheet feeding device 40 primarily includes one or more than one sheet holder 41 and a sending-out device 42. The sheet holder 41 is mounted so as to be capable of being drawn out towards the front side (a side facing an operator when the operator uses the sheet feeding device) of the housing 10, and holds pieces of recording paper 9 of, for example, desired sizes and types in a stacked state. The sending-out device 42 sends out the pieces of recording paper 9 one sheet at a time from the sheet holder 41. The pieces of recording paper 9 that are sent out from the sheet feeding device 40 are transported to a second transfer position (situated between the intermediate transfer belt 31 and a second transfer belt 351 of the second transfer device 35) via a transport path formed by a pair of sheet transport rollers 43a, a pair of sheet transport rollers 43b, a pair of sheet transport rollers 43c, . . . , and a transport guide member. A transporting device (not shown) that transports the pieces of recording paper 9 after the second transfer is set between the second transfer device 35 and the fixing device 45.

The fixing device 45 includes a heating rotating member 47 and a pressure rotating member 48 in a housing 46. The heating rotating member 47 rotates in the direction of the arrow, and is heated by a heating unit that maintains a surface temperature of the heating rotating member 47 at a predetermined temperature. The pressure rotating member 48 contacts the heating rotating member 47 substantially along an axial direction of the heating rotating member 47 with a predetermined pressure, and is driven and rotated by the heating rotating member 47. The recording paper 9 to which the toner images are fixed by the fixing device 45 passes along a discharge transport path (formed by pairs of transport rollers and a transport guide member), and is transported to and held by a discharge section (not shown) that is set at, for example, the housing 10.

Next, a basic image forming operation (a printing operation) performed by the image forming apparatus 1 will be described. Here, a pattern for an image forming operation for forming a full-color image formed by combining toner images of four colors (Y, M, C, K), formed using all four of the image forming devices 20Y, 20M, 20C, and 20K, will be described as a typical example.

If there is an instruction for requesting an image forming operation (a printing operation) from, for example, the aforementioned image information device, the following occurs in each of the four image forming devices 20Y, 20M, 20C, and 20K. That is, first, each photoconductor drum 21 rotates in the direction of arrow A, and each charging device 22 charges the image carrying surface of the associated photoconductor drum 21 to a required polarity (a negative polarity in the exemplary embodiment) and potential. Then, each exposing device 23 irradiates and exposes the surface of the associated charged photoconductor drum 21 with light that is emitted on the basis of image data divided into each of the color components (Y, M, C, K) transmitted from the image processing device, so that electrostatic latent images of the corresponding color components formed by required potential differences are formed.

Then, in each of the developing devices 5Y, 5M, 5C, and 5K, the developing rollers 51 and 52 supply toner of the corresponding color (Y, M, C, K), charged to a required polarity (a negative polarity), to the electrostatic latent images of the associated color component, formed on the associated photoconductor drum 21, so that the toner of the associated color electrostatically adheres to the electrostatic latent image. By performing such development operations, the electrostatic latent images of the corresponding color components, formed on the corresponding photoconductor drums 21, are developed with the toners of the corresponding colors, to make them visible as the toner images of the four colors (Y, M, C, K).

Then, the first transfer devices 25 first-transfer the toner images of the corresponding colors, formed on the photoconductor drums 21 of the respective image forming devices 20Y, 20M, 20C, and 20K, to the intermediate transfer belt 31, which rotates in the direction of arrow B of the intermediate transfer device 30, so as to be successively superimposed upon each other. Any extraneous matter, such as toner, remaining on the outer peripheral surfaces of the photoconductor drums 21 after the first transfer in the respective image forming devices 20 are recharged by the prior-to-cleaning devices 26 and, then, removed and cleaned off by the drum cleaning devices 27. Then, any electricity at the cleaned outer peripheral surfaces of the photoconductor drums 21 is removed by the electricity removing devices 28.

Then, in the intermediate transfer device 30, after transporting the toner images first-transferred to the intermediate transfer belt 31 to the second transfer section, the toner images on the intermediate transfer belt 31 are, at the second transfer section, collectively second-transferred to a piece of recording paper 9 that is transported and sent from the sheet feeding device 40. Any extraneous matter, such as toner, remaining on the outer peripheral surface of the intermediate transfer belt 31 is removed and cleaned off by the belt cleaning device 36.

Finally, the recording paper 9 to which the toner images have been second-transferred is separated from the intermediate transfer belt 31, and, then, is transported and led to the fixing device 45. At the fixing device 45, the toner images are subjected to required fixing operations (heating operation and pressing operation), so that the unfixed toner images are fixed to the recording paper 9. When the image forming operation is one that is performed on only one side of the recording paper 9, the recording paper 9 after the fixing is discharged to and held by, for example, a discharge holding section (not shown) that is formed at the housing 10.

By the above-described operations, the recording paper 9 on which a full-color image has been formed by combining the toner images of the four colors is output to the outside of the housing 10.

Next, each developing device 5 will be described in more detail.

As shown from, for example, FIG. 2 to FIG. 4B, each developing device 5 includes a body 50 including a container chamber 50a that contains the aforementioned two-component developer G and a rectangular opening 50b that is formed so as to oppose the associated photoconductor drum 21. The body 50 has the shape of an elongated container whose length exceeds the length of the photoconductor drum 21 in an axial direction thereof. A bottom portion of the container chamber 50a has a form including two developer circulating transport paths (grooves) that are partitioned at a center portion by a partitioning projection extending along a longitudinal direction and whose ends in the longitudinal direction in the elongated container shape are connected to each other. The container chamber 50a contains the two-component developer G.

As shown in, for example, FIG. 3, each developing device 5 includes, for example, the developing rollers 51 and 52 (first developing roller 51 and second developing roller 52), two screw augers 54 and 55, a passage regulating plate 56, a distributing member 57, and a collecting guiding plate 58 in the body 50. The two developing rollers 51 and 52 carry and transport the developers G by magnetic forces up to a development area E1 and a development area E2, respectively. The development areas E1 and E2 are where the developing roller 51 opposes the photoconductor drum 21 and where the developing roller 52 opposes the photoconductor drum 21, respectively. The two screw augers 54 and 55 serve as stirring transporting members that stir and transport the developer G contained in the container chamber 50a. The passage regulating plate 56 regulates the passage of the developer G that is supplied to the second developing roller 52 from the screw auger 55, and regulates the thickness of a layer of the developer G (transport amount). The distributing member 57 distributes the developer G transported from the second developing roller 52 to the first developing roller 51. The collecting guiding plate 58 guides the developer G that is separated from the first developing roller 51 so that the developer G returns to the container chamber 50a.

The first and second developing rollers 51 and 52 are disposed so as to rotate in required directions C and D, respectively, while portions thereof are exposed from the opening 50b of the body 50. The two developing rollers 51 and 52 are disposed with the two developing rollers 51 and 52 being spaced apart from each other by a required interval δ in a rotation direction A of the photoconductor drum 21. A portion (space) where the developing rollers 51 and 52 are closest to each other is formed as a closest portion 53.

The first developing roller 51 includes a circular cylindrical sleeve 51A that is supported so as to be rotationally driven in the direction of arrow C while being spaced apart by a required interval a at the first development area E1 at the outer peripheral surface of the photoconductor drum 21, and a magnet roller 51B that is provided so as to exist in a fixed state to an inner side of the sleeve 51A. The direction of arrow C of the sleeve 51A is set so that the direction of movement of the sleeve 51A at the first development area E1 of the photoconductor drum 21 is opposite to the rotation (movement) direction A of the photoconductor drum 21.

The second developing roller 52 includes a circular cylindrical sleeve 52A and a magnet roller 52B. The sleeve 52A is supported so as to be rotationally driven in the direction of arrow D while being spaced apart by a required interval β at the second development area E2 at the outer peripheral surface of the photoconductor drum 21, the second development area E2 being disposed downstream from the first development area E1. The magnet roller 52B is provided so as to exist in a fixed state to an inner side of the sleeve 52A. The direction of arrow D of the sleeve 52A is set so that the direction of movement of the sleeve 52A at the second development area E2 of the photoconductor drum 21 is the same as the rotation (movement) direction A of the photoconductor drum 21.

The sleeves 51A and 52A are formed of nonmagnetic materials (such as stainless steel or aluminum). Each of the sleeves 51A and 52A is formed so as to have at least a circular cylindrical portion having a width (length) that is substantially the same as that of an effective image formation area of the photoconductor drum 21 in a direction of an axis of rotation thereof.

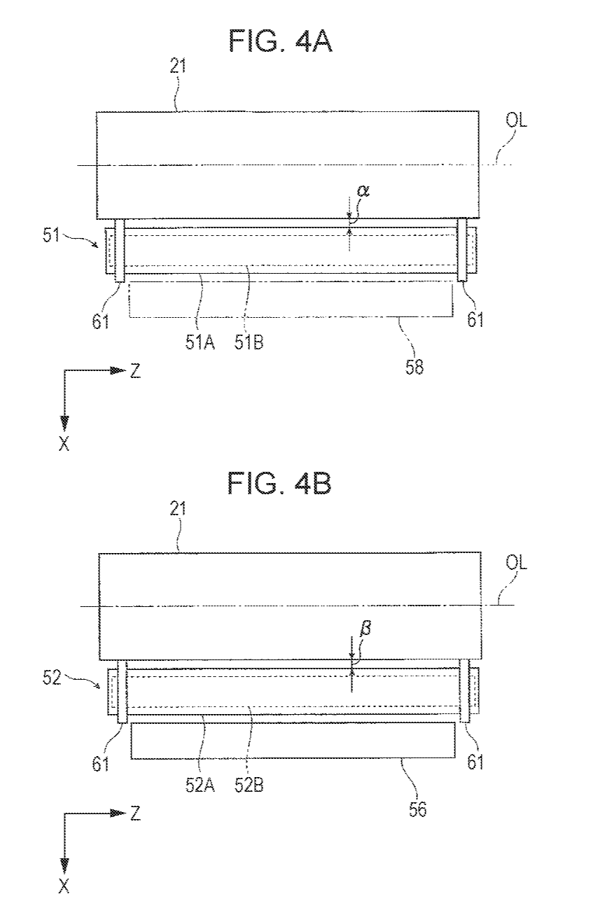

As shown in FIGS. 4A and 4B, the sleeves 51A and 52A are disposed so that their directions of the axes of rotations are substantially parallel to and oppose a direction OL of an axis of rotation of the photoconductor drum 21. Both end portions of each of the sleeves 51A and 52A are formed as shaft portions. Interval maintaining rings (tracking rollers) 61 are mounted to the respective end portions of the sleeve 51A and to respective end portions of the sleeve 52A. The interval maintaining rings 61 are larger than outer peripheral surfaces of the sleeves 51A and 52A by the interval α and the interval β, respectively. The sleeves 51A and 52A are rotatably received by a side surface of the body so as to rotate with the interval maintaining rings 61 being pressed against the outer peripheral surface of the photoconductor drum 21 with a required pressure. The sleeves 51A and 52A are rotated in the directions of arrows C and D, respectively, when one end of each shaft portion receives required rotational power from, for example, a rotary driving device (not shown). Development voltages for forming development electric fields between the sleeve 51A and the photoconductor drums 21 and between the sleeve 52A and the photoconductor drum 21 are applied to the sleeves 51A and 52A from a power supply device (not shown). As the development voltages, for example, direct-current voltages upon which alternating components are superimposed are applied.

The magnet rollers 51B and 52B are formed by disposing magnetic poles (south poles and north poles) that generate, for example, magnetic lines of force that cause the magnetic carriers of the developers G to be carried by the outer peripheral surfaces of the sleeves 51A and 52A with magnetic brushes being formed. The magnet rollers 51B and 52B are mounted in a fixed state to a side surface of the body 50 by passing both ends thereof into internal spaces in the shaft portions of the respective development sleeves 51A and 52A. The magnetic poles extend along axial directions of the sleeves 51A and 52A, and are disposed at required positions so as to be spaced apart from each other in peripheral directions (directions of rotations) of the sleeves 51A and 52A.

As shown in, for example, FIG. 3, the screw augers 54 and 55 each have a form in which a transporting blade is spirally wound around a peripheral surface of a rotary shaft. The screw augers 54 and 55 are set in a rotatable state in the two developer circulating transport paths formed in the container chamber 50a of the body 50 by the partition wall. The developer G that exists in the transport paths is rotationally driven in a required direction in which it should be transported. The augers 54 and 55 are rotated when portions of powers that rotate the sleeve 51A of the developing roller 51 and the sleeve 52A of the developing roller 52 are branched and transmitted by a drive transmitting mechanism, such as a gear. The screw auger 55 that is disposed close to the second developing roller 52 is such that a portion of the developer G that is transported is supplied to the second developing roller 52.

As shown in, for example, FIG. 3 and FIGS. 4A and 4B, the passage regulating plate 56 is a rectangular plate member whose principal portion has a substantially constant thickness and that has a long side that is at least as long as the sleeve 52A of the second developing roller 52 in the axial direction of the sleeve 52A. The regulating plate 56 is formed of an nonmagnetic material (such as stainless steel). Further, the regulating plate 56 is mounted to a supporting member 59 of the body 50 so that one end portion (lower long side portion) in a longitudinal direction thereof opposes the outer peripheral surface of the sleeve 52A while being spaced apart by a required interval (regulation interval) therefrom, and opposes the outer peripheral surface of the sleeve 52A while extending along the axial direction of the sleeve 52A. The regulating plate 56 in the first exemplary embodiment is formed as a plate member whose other end is bent so as to be have an overall L shape in cross section.

As shown in, for example, FIG. 3, the distributing member 57 is a rod-shaped member having a length extending along the axial directions of the two developing rollers 51 and 52 and having a wedge-shape (triangular shape) in cross section, and has distribution surfaces (triangular oblique sides) that oppose the outer peripheral surfaces of the sleeves 51A and 52A of the respective developing rollers 51 and 52. The distributing member 57 is disposed closer to the photoconductor drum 21 than the closest portion 53 between the two developing rollers 51 and 52 with its tapering end portion opposing the closest portion 53 and with distributing surfaces thereof being spaced apart at an equal interval from the outer peripheral surfaces of the respective sleeves 51A and 52A. The distributing member 57 is mounted by securing mounting portions that protrude from both ends thereof to a side surface of the body 50.

The collecting guide plate 58 is a plate member having a surface that allows the developer that is separated from the first developing roller 51 to slide and fall so as to return to the container chamber 50a after receiving the developer. As shown in, for example, FIG. 3, an upper end portion 58a of the collecting guide plate 58 opposes the outer peripheral surface of the sleeve 52A so as to be spaced apart by a predetermined interval therefrom at a location between a magnetic pole S3 and a magnetic pole S2, serving as separating poles of the first developing roller 51. In addition, as shown in, for example, FIG. 3, a lower end portion 58b of the collecting guide plate 58 is mounted to the supporting member 59 so as to extend gradually downward from the upper end portion 58a and finally reaches a location that is close to the upper side of the screw auger 55.

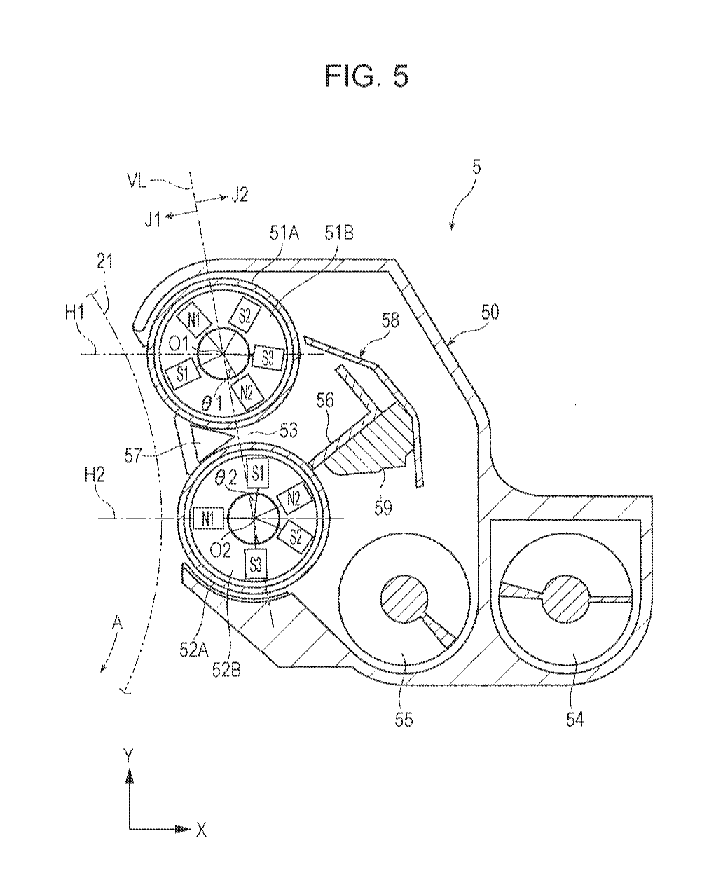

As shown in, for example, FIG. 5, in the magnet roller 51B of the first developing roller 51 in each developing device 5, five magnetic poles, that is, N2, S1, N1, S2, and S3 are disposed. Of the magnetic poles, the magnetic pole N2 is a division assisting transport pole that is disposed close to the second developing roller 52 and that generates magnetic lines of force that divide a portion of the developer, which is transported by the developing roller 52, at a side of the outer peripheral surface of the sleeve 51A, and moves the divided portions of the developer. The magnetic pole S1 is a development pole that is disposed so as to oppose the first development area E1 at the photoconductor drum 21, and that contributes to a development step using the developer G. The magnetic pole N1 is a transport pole. The magnetic poles S2 and S3 are pickoff poles that have the same magnetic properties, generate repulsive magnetic fields (magnetic lines of force), and separate the developer G from the outer peripheral surface of the sleeve 51A.

As shown in, for example, FIG. 5, the magnet roller 52B of the second developing roller 52 in each developing device, five magnetic poles, S2, N2, S1, N1, and S3 are disposed. Of the magnetic poles, the magnetic pole N2 is a pickup pole that is disposed so as to substantially oppose a drum-21-side upper end portion of the screw auger 55 disposed close to the second developing roller 52, and that performs pickup by causing the developer G supplied from the screw auger 55 to be attracted towards and carried by the outer peripheral surface of the sleeve 52A by magnetic force. The magnetic pole N2 is a regulation assisting pole that causes the magnetic brushes for assisting the regulation of the developer by the passage regulating plate 56 to stand to a required extent. The magnetic pole S1 is a division assisting transport pole that is disposed while substantially opposing the division assisting transport pole N2 of the first developing roller 51, and that causes magnetic lines of force to be generated by cooperating with the division transport pole N2 of the magnet roller 51B of the first developing roller 51. The magnetic lines of force cause a portion of the developer, which is transported by the developing roller 52, to be divided at a side of the outer peripheral surface of the sleeve 51A, and moves the divided portions of the developer. The magnetic pole S1 is a development pole that is disposed so as to oppose the second development area E2 at the photoconductor drum 21, and contributes to the development step using the developer G. The magnetic pole S3 is a pickoff pole that performs pickoff by causing a repulsive magnetic force to be generated between the pickup magnetic pole S2 and the magnetic pole S3, and causing the developer G to separate from the outer peripheral surface of the sleeve 52A.

A basic operation of each developing device 5 will hereunder be described.

In each developing device 5, when an image forming operation is to be performed by the image forming apparatus 1, the sleeve 51A of the developing roller 51, the sleeve 52A of the developing roller 52, the screw auger 54, and the screw auger 55 start to rotate, and development voltages are applied to the sleeves 51A and 52A.

This causes the two-component developers G contained in the container chamber 50a of the body 50 to be transported in respective directions in the two circulating transport paths in the container chamber 50a while being stirred by the augers 54 and 55 that rotate, so that the two-component developers G are transported so as to circulate as a whole. At this time, the nonmagnetic toners in the developers G are, along with the magnetic carriers, sufficiently stirred and friction-charged, and electrostatically stuck on the surfaces of the carriers.

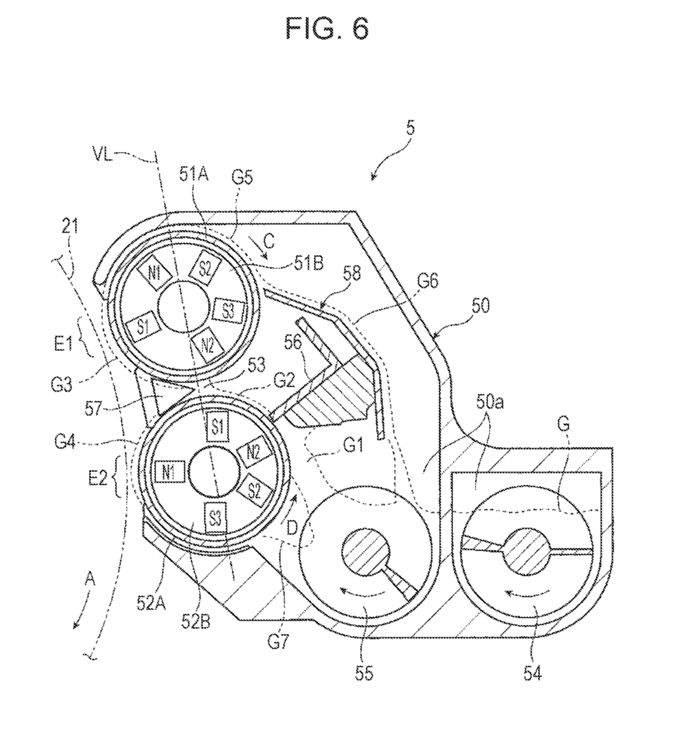

Then, as shown in FIG. 6, a portion G1 of the two-component developer G that is transported by the screw auger 55 disposed close to the second developing roller 52 is carried so as to be attracted to the outer peripheral surface of the sleeve 52A of the second developing roller 52 by magnetic force. That is, since magnetic force (magnetic lines of force) generated from the magnetic pole S2 of the magnet roller 52B affects the outer peripheral surface of the sleeve 52A that rotates, the portion G1 is carried and supplied with a magnetic brush being formed. In the magnetic brush, the magnetic carriers to which the toner is stuck are connected in the form of a chain and stand.

Next, as shown in FIG. 6, a portion of the portion G1 of the two-component developer G carried by the second sleeve 52A is stopped by the passage regulating plate 56, and another portion thereof is allowed to pass while the portion G1 of the two-component developer G is being transported as the sleeve 52A rotates. That is, the portion G1 of the developer G that reaches the passage regulating plate 56 is formed as a magnetic brush and stands up while receiving magnetic force of the regulation assisting magnetic pole N2, and a portion of the portion G1 of the developer G is stopped by the passage regulating plate 56, so that almost all of the portion G1 of the developer G is returned to the container chamber 50a. The passage of a remaining portion G2 of the developer G is regulated as it passes a gap formed between the sleeve 52A and the regulating plate 56, and is formed into a substantially constant layer thickness (transport amount).

Next, as shown in FIG. 6, the portion G2 of the developer G after being regulated by the regulating plate 61 reaches the closest portion 53 between the second developing roller 52 and the first developing roller 51, after which the portion G2 of the developer G passes the distributing member 57. At this time, when the portion G2 of the developer G passes the closest portion 53, magnetic force generated between the division assisting transport pole N2 of the developing roller 51 and the division assisting transport pole S1 of the developing roller 52 that oppose each other causes the portion G2 of the developer G to be formed into a magnetic brush. Therefore, the developer G is in a state in which it tends to move from the developing roller 52 to the developing roller 51. In this state, the portion G2 of the developer G passes the distributing member 57 and is divided in two portions (G3, G4). The portions G3 and G4 of the developer G are distributed to the first developing roller 51 and the second developing roller 52, respectively.

At this time, when the portion G3 of the developer that has been distributed to the first developing roller 51 is transported by the sleeve 51A that rotates in the direction of arrow C, and passes the first development area E1 at the photoconductor drum 21, the portion G3 of the developer receives the magnetic force generated by the development magnetic pole S1, and is subjected to the action of a development electric field generated by development voltage. This causes the toner of the portion G3 of the developer G in the magnetic brush to move to the photoconductor drum 21, and to stick to a latent image portion that passes the first development area E1, so that the latent image portion is developed.

Finally, a portion G5 of the developer G that has passed the first development area E1 receives magnetic force of the transport pole N1, after which a repulsive magnetic force generated between the magnetic poles S2 and S3, serving as separating poles, cause the portion G5 to be separated as a portion G6 of the developer G from the outer peripheral surface of the sleeve 51A. The portion G6 is collected by the collecting guiding plate 58 so as to be received thereby, and is guided and returned to the container chamber 50a.

The portion G4 of the developer G distributed to the second developing roller 52 is transported by the sleeve 52A that rotates in the direction of arrow D. When the portion G4 of the developer G passes the second development area E2 at the photoconductor drum 21, the portion G4 receives a magnetic force generated by the development magnetic pole N1, and is subjected to the action of a development electric field generated by development voltage. This causes the toner of the magnetic brush of the portion G4 of the developer G to move to the photoconductor drum 21, and to stick to a latent image portion that passes the second development area E2, so that the latent image portion is developed.

A portion G7 of the developer G that has passed the second development area E2 receives a repulsive magnetic force generated between the magnetic poles S3 and S2 (serving as separating poles), is separated from the outer peripheral surface of the sleeve 52A, falls naturally, and is returned to the container chamber 40a.

In an existing developing device 500, in particular, a division assisting transport pole N2 of a magnet roller 51B of a first developing roller 51 and a division assisting transport pole S1 of a magnet roller 52B of a second developing roller 52 are generally disposed as follows.

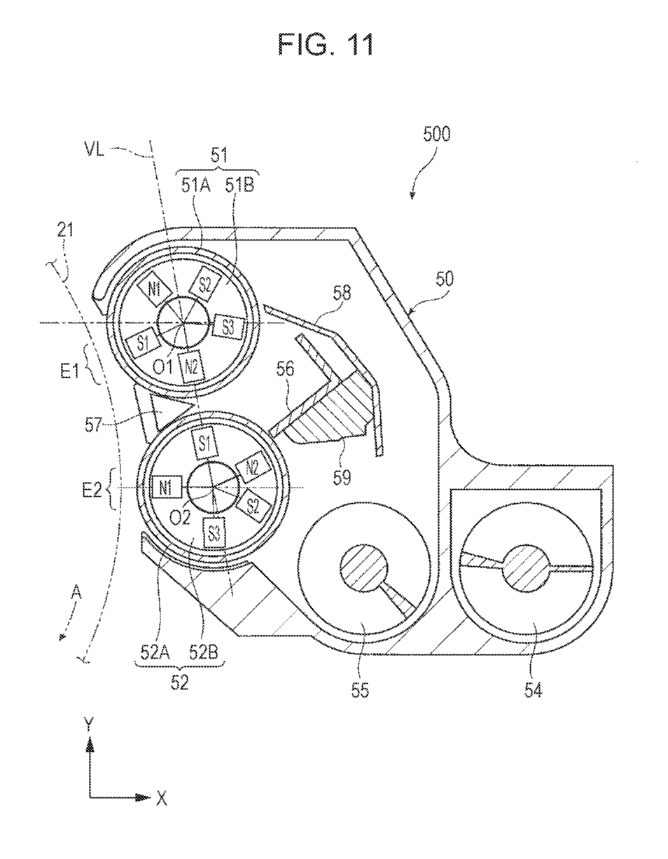

That is, as shown in FIG. 11, the division assisting transport pole N2 of the magnet roller 51B and the division assisting transport pole S1 of the magnet roller 52B are disposed so as to oppose each other at a location where the first developing roller 51 and the second developing roller 52 are closest to each other. In other words, the division assisting transport pole N2 and the division assisting transport pole S1 are disposed so as to overlap a virtual straight line (VL) connecting a center position O1 of the magnetic roller 51B corresponding to the center of rotation of the first developing roller 51 and a center position O1 of the magnetic roller 52B corresponding to the center of rotation of the second developing roller 52.

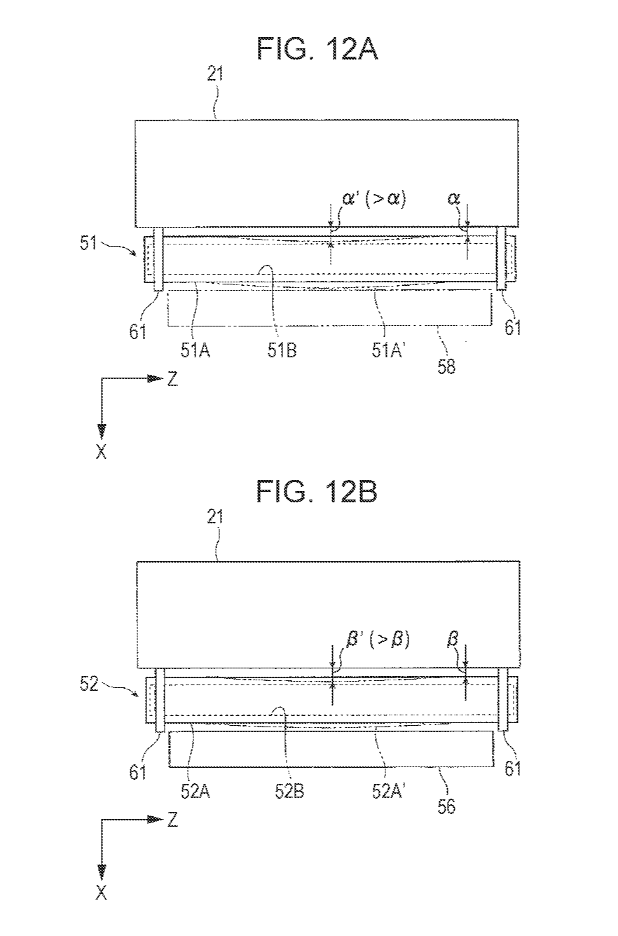

However, when, as in the existing developing device 500, the division assisting transport pole N2 and the division assisting transport pole S1 are disposed so as to oppose each other at the portion where the first developing roller 51 and the second developing roller 52 are closest to each other, as shown in FIGS. 12A and 12B, a sleeve 51A and a sleeve 52A are rotated while being deformed so as to be flexed in a direction M away from the outer peripheral surface of the photoconductor drum 21. The sleeve 51A and the sleeve 52A are flexed by an increasing amount towards the center of the developing roller 51 and the developing roller 52 in an axial direction thereof. As a result, uneven developer density caused by the flexing may occur. Uneven developer density in the axial direction caused by the flexing (that is, in particular, uneven density in which the density becomes relatively low towards the center in the axial direction) may occur. In FIG. 12A, symbol 51A′ denotes a flexed portion of the sleeve 51a, and symbol α′ denotes a maximum distance between the flexed portion 51A′ of the sleeve 51A and the photoconductor drum 21. In FIG. 12B, symbol 52A′ denotes a flexed portion of a sleeve 52A, and symbol β′ denotes a maximum distance between the flexed portion 52A′ of the sleeve 52A and the photoconductor drum 21.

It is assumed that the flexing occurs due to the following reasons.

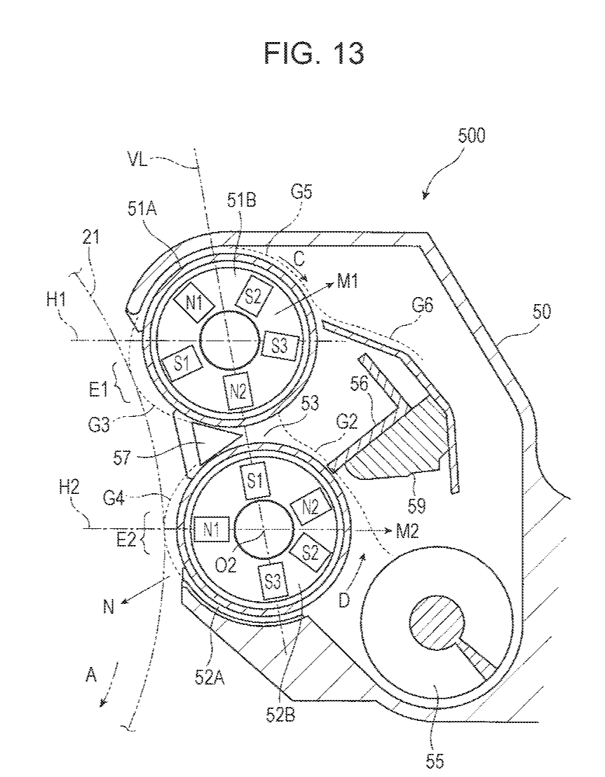

That is, as shown in FIGS. 12A and 12B (FIG. 3) or FIG. 13, the developing rollers 51 and 52 (sleeves 51A and 52B) are disposed and rotated with the developer rollers 51 and 52 being spaced apart from the photoconductor drum 21 by small intervals α and β in the respective development areas E1 and E2 where they are closest to the photoconductor drum 21. In addition, since the portions G3 and G4 of the developer G are successively sent into a gap between the developing roller 51 and the photoconductor drum 21, and a gap between the developing roller 52 and the photoconductor drum 21, very high pressures are maintained in the respective gaps. The pressures cause the sleeve 51A of the developing roller 51 and the sleeve 52B of the developing roller 52 to be pressed in directions M1 and M2 away from the photoconductor drum 21, respectively. Here, the cleaning plate (cleaning blade) 27b of the drum cleaning device 27 contacts with a required pressure a portion of an outer peripheral surface of the photoconductor drum 21 opposite the two developing rollers 51 and 52 with the center of rotation of the photoconductor drum 21 being disposed between the cleaning plate 27b and the sleeves 51A and 52B (see FIG. 2). Therefore, the photoconductor drum 21 itself does not move away from the developing device 5. The sleeves 51A and 52B are set while being pushed with predetermined pressures against the photoconductor drum 21 through the tracking rollers 61 as mentioned above (FIGS. 4A and 4B).

Therefore, as shown in FIGS. 12A and 12B, it is believed that the sleeves 51A and 52B are deformed so as to be flexed in the directions M away from the outer peripheral surface of the photoconductor drum 21. The sleeve 51A and the sleeve 52A are flexed by a greater amount towards the center of the sleeve 51A and the sleeve 52A in the axial direction thereof (see FIGS. 4A and 4B).

In the developing device 500, a passage regulating plate 56 is disposed in a fixed state at a position that is substantially opposite the photoconductor drum 21 in the vicinity of the second developing roller 52. Therefore, a portion G1 of developer G that is supplied to the sleeve 52A is attracted and carried by a large amount, and a portion G2 of the developer G also exists between the photoconductor drum 21 and the passage regulating plate 56. Therefore, as shown in FIG. 13, the sleeve 52A is pushed in a direction N approaching the photoconductor drum 21. A flexing amount (β′-β) of the sleeve 52A is less than a flexing amount (α′-α) of the sleeve 51A of the first developing roller 51.

Almost all of a portion G5 of the developer G is separated from the first developing roller 51 after the development. Therefore, the amount of developer G carried by the outer peripheral surface of the sleeve 51A thereof is less than the amount of developer G carried by the sleeve 52A of the second developing roller 52. Consequently, from the viewpoint of, for example, performing proper development, the interval α between the sleeve 51A and the photoconductor drum 21 may be set less than the interval β between the sleeve 52A of the second developing roller 52 and the photoconductor drum 21 (α<β). When the interval α is set less than the interval β, the sleeve 51A receives the pressure generated by a portion G3 of the developer G existing between the sleeve 51A and the photoconductor drum 21, as a result of which the sleeve 51A tends to deform so as to flex largely in the direction M1 away from the photoconductor drum 21.

Here, in each developing device 5, as shown in, for example, FIG. 5, the division assisting transport pole N2 of the magnetic roller 51B and the division assisting transport pole S1 of the magnet roller 52B are disposed in an area (J2) that is opposite an area (J1), at whose side the photoconductor drum 21 exists, with a virtual straight line (VL) being a boundary thereof. The virtual straight line (VL) connects a center position O1 of the magnetic roller 51B corresponding to the center of rotation of the first developing roller 51 and a center position O1 of the magnetic roller 52B corresponding to the center of rotation of the second developing roller 52. Straight dotted lines H1 and H2 in, for example, FIG. 5 are substantially parallel to a horizontal direction (that is, a direction parallel to a coordinate axis X).

In other words, in each developing device 5, the division assisting transport pole N2 and the division assisting transport pole S1 are disposed in a shifted state from the virtual straight line so as to exist in the area (J2) at whose side the photoconductor drum 21 does not exist. More specifically, the division assisting transport pole N2 and the division assisting transport pole S1 are disposed so that a center angle θ1 between the center position (O1) of the division assisting transport pole N2 and the virtual straight line (VL) and a center angle θ2 between the center position O2 of the division assisting transport pole S1 and the virtual straight line (VL) are in a range of from 10 degrees to 30 degrees. Accordingly, as regards whether or not the division assisting transport pole N2 and the division assisting transport pole S1 are disposed in a shifted state so as to exist in the area (J2) at whose side the photoconductor drum 21 does not exist, it is possible to confirm approximate positions thereof by checking the amount by which the position of the division assisting transport pole N2 is shifted from the position where the sleeve 51A crosses the virtual straight line VL and the amount by which the division assisting transport pole S1 is shifted from the position where the sleeve 52A crosses the virtual straight line VL. The checking is performed on the basis of, for example, a result obtained by observing the states of adhesion of the developers on the sleeves 51A and 52A of the respective developing rollers 51 and 52 (such as positions of portions where chain standing heights of developer are relatively large) or a result obtained by actually measuring the magnetic forces at the developing rollers 51 and 52 (such as positions where peak magnetic forces are generated).

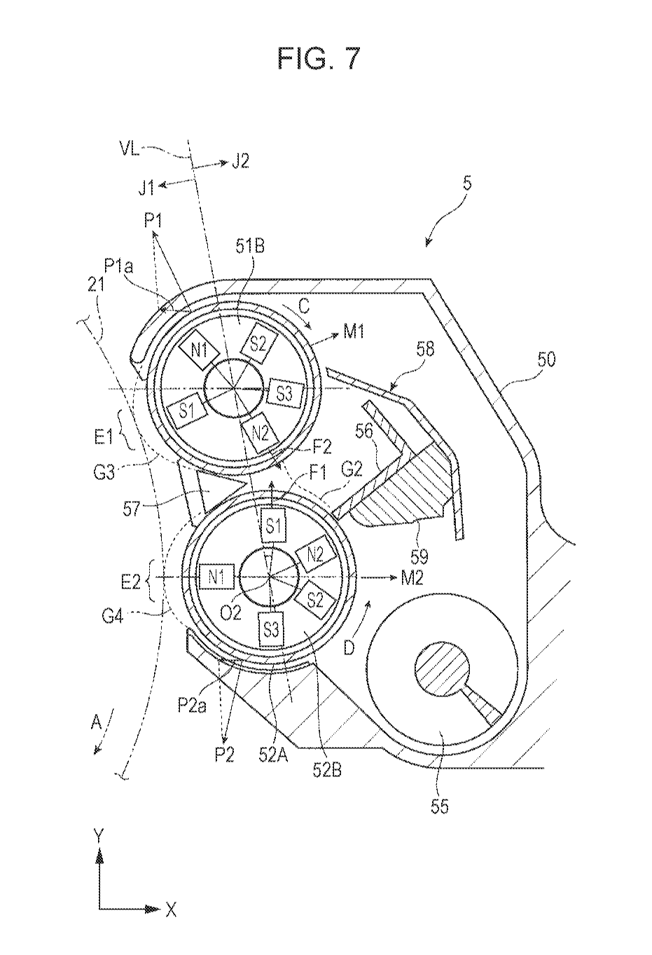

Therefore, in each developing device 5 according to the first exemplary embodiment, the division assisting transport pole N2 of the magnet roller 51B and the division assisting transport pole S1 of the magnet roller 52B are disposed in the area (J2) that is opposite the area (J1), at whose side the photoconductor drum 21 exists, with the virtual straight line (VL) being a boundary thereof. Consequently, as exemplified in FIG. 7, the magnet roller 51B and the magnet roller 52B are attracted towards each other by a magnetic attraction force F2 of the division assisting transport pole N2 and a magnetic attraction force F1 of the division assisting transport pole S1, the transport magnetic poles N2 and S1 having different magnetic properties. Here, since the portion G2 of the developer G is carried by and exists at the closest portion 53 by the magnetic attraction forces F2 and F1, the portion G2 of the developer G causes the sleeves 51A and 52A to receive forces P1 and P2, respectively, that push the sleeves 51A and 52A in directions that are substantially opposite to the directions of the magnetic attraction forces F2 and F1, respectively. The forces P1 and P2 that push the sleeves 51A and 52A, respectively, at this time become forces including forces P1a and P2a acting in directions approaching the photoconductor drum 21.

As a result, even if the sleeves 51A and 52A of each developing device 5 may receive forces acting in directions M1 and M2 away from the photoconductor drum 21 due to the portions G3 and G4 of the developer G existing at the development areas E1 and E2 of the photoconductor drum 21, respectively, the forces acting in the directions M1 and M2 are offset and reduced even if only slightly by the forces P1a and P2a. Therefore, the flexing of the sleeves 51A and 52A in the directions away from the photoconductor drum 21 is suppressed by an increasing extent towards the center positions of the sleeves 51A and 52A in axial directions thereof.

In the image forming apparatus 1 using each of the developer devices 5, flexing of the sleeve 51A of the developing roller 51 and the sleeve 52A of the sleeve 52 in each developing device 5 is suppressed. Therefore, uneven image density caused by uneven development density resulting from such flexing (that is, uneven density in which image density at a central portion of each of the developing rollers 51 and 52 in the axial direction thereof is reduced) is reduced.

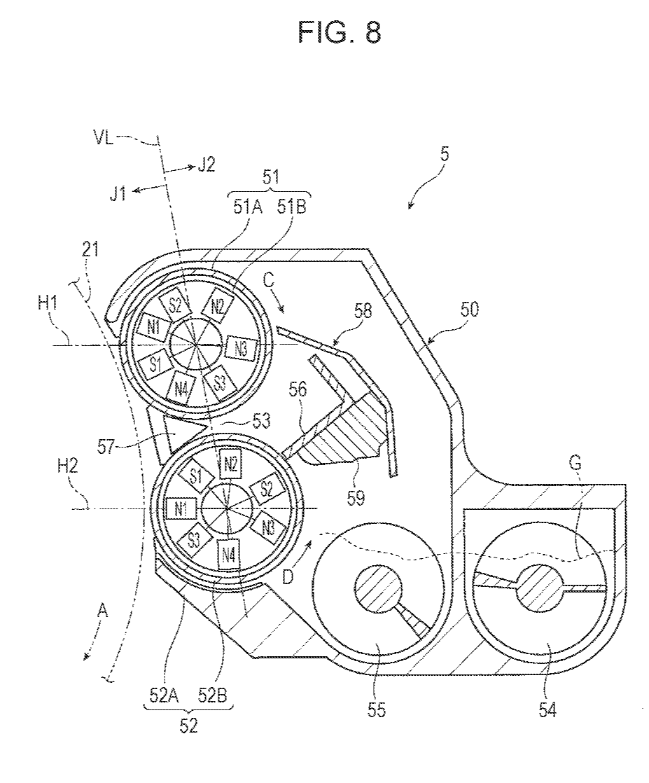

FIG. 8 shows another exemplary structure in which magnetic poles of the magnet roller 51B of the first developing roller 51 and magnetic poles of the magnet roller 52B of the second developing roller 52 are arranged differently.

In the magnet roller 51B of the first developing roller 51 exemplified in FIG. 8, seven magnetic poles, S3, N4, S1, N1, S2, N2, and N3 are disposed. Of the magnetic poles, the magnetic pole N3 is a division assisting transport pole that is disposed so as to exist in the area (J2) that is situated opposite the area (J1), at whose side the photoconductor drum 21 exists, as mentioned above. The magnetic pole S1 is a development electrode at the first development area E1. The magnetic poles N4 and N1 are transport assisting poles that assist the transport of the developer G in areas situated at the front and back of the development pole S1, that is, upstream and downstream from the development pole S1 in a rotation direction C of the sleeve 51A. The magnetic pole S2 is a transport pole that transports the developer D after the developer D has passed the development area E1. The magnetic poles N2 and N3 are poles that perform developer pickoff.

In the magnet roller 52B of the second developing roller 52, seven magnetic poles, N3, S2, N2, S1, N1, S3, and N4 are disposed. Of these magnet poles, the magnetic pole N3 is a pole that performs developer pickup, and the magnetic pole S2 is a regulation assisting pole. The magnetic pole N2 is a division assisting transport pole that is disposed so as to exist in the area (J2) that is situated opposite the area (J1), at whose side the photoconductor drum 21 exists, as mentioned above. The magnetic pole S1 is a development electrode at the second development area E2. The magnetic poles S1 and S3 are transport assisting poles that assist the transport of the developer G in areas situated at the front and back of the development pole N1, that is, upstream and downstream from the development pole N1 in a rotation direction D of the sleeve 52A. The magnetic pole N4 is a pole that performs developer pickoff in cooperation with the magnetic pole N3.

In each developing device 5 that uses the magnetic rollers 51B and 52B exemplified in FIG. 8 to which the transport assisting electrodes are added, it is possible to stably and properly transport the required amount of developer to the two development areas E1 and E2, so that proper development with even reduced uneven density is performed.

### Second Exemplary Embodiment

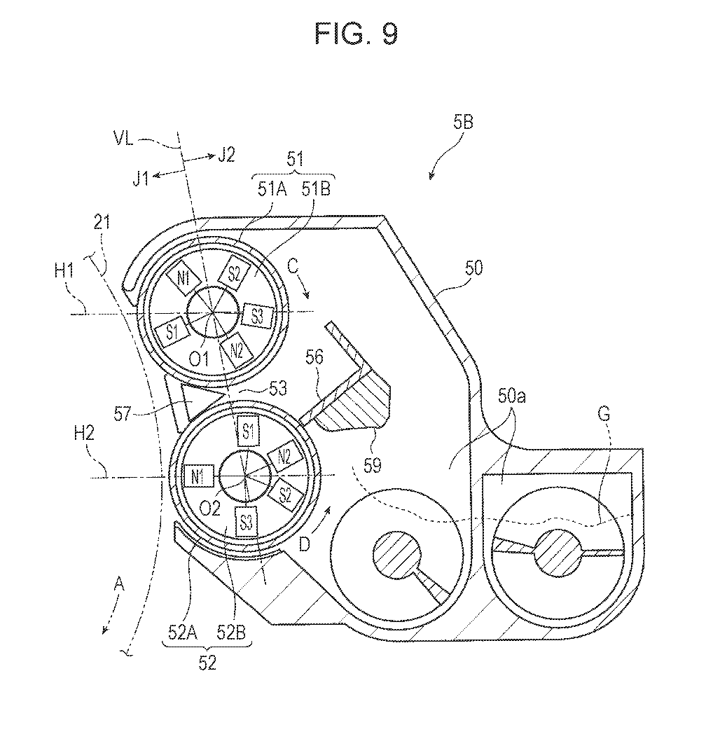

FIG. 9 shows each developing device 5B according to a second exemplary embodiment.

Each developing device 5B according to the second exemplary embodiment differs from the developing device 5 (FIG. 5) in that each developing device 5B is not provided with a collecting guiding plate 58. The other structural features are the same. The carrying of a portion of developer G5 that is carried by a portion of a sleeve 51A of a first developing roller 52 that has passed a first development area E1 is continued, without separating and returning this portion of the developer G5 to a container chamber 50a. The structure of a magnet roller 51B of a developing roller 51 and the structure of a magnet roller 52B of the developing roller 52 in each developing device 5B are the same as that of the magnet roller 51B and that of the magnet roller 52B in the first exemplary embodiment (FIG. 5), respectively (that is, the arrangements of magnetic poles are the same).

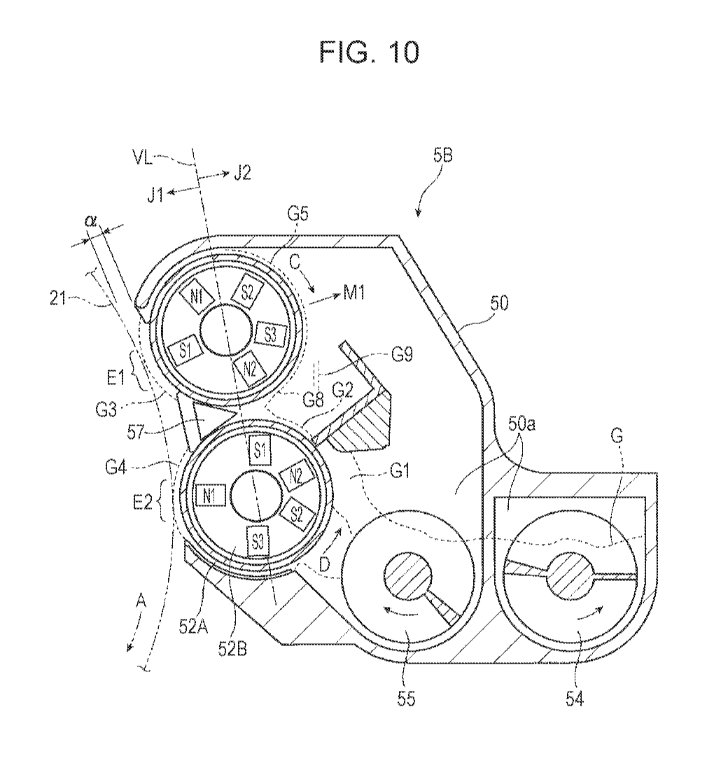

The basic operation of each developing device 5B is substantially the same as the basic operation of each developing device 5 in the above-described first exemplary embodiment. It differs on the following points. That is, as shown in FIG. 10, in the first developing roller 51, developer G9, which is a portion of the developer G5 that is held by the sleeve 51A after the developer G5 has passed the first development area E1, is separated by a repulsive magnetic force generated between magnetic poles S2 and S3 serving as separating poles. The other portions of the developer G5 are transported while being carried by the sleeve 51A. The total quantity of developer G that is carried by an outer peripheral surface of the sleeve 51A of the first developing roller 51 is greater than that in each developing device 5 in the first exemplary embodiment in correspondence with the reduced quantity of developer that is separated.

As a result, a sufficient amount of developer G3 also exists when the developer G3 passes the first development area E1 of the first developing roller 51. Therefore, an interval α between a photoconductor drum 21 and the sleeve 51A of the first developing roller 51 need not be set less than, for example, an interval β between the photoconductor 21 and the second developing roller 52. These intervals α and β may be set equal to each other. Since it is no longer necessary to set the interval α less than the interval β, it is possible to reduce an increase in pressure generated by the developer G3 existing between the first developing roller 51 and the first development area E1 at the photoconductor drum 21. Therefore, it is possible to reduce the force that pushes the sleeve 51A in a direction M1 away from the photoconductor drum 21. Consequently, it is possible to suppress flexing of the sleeve 51A in the direction M1 that increases towards the center position of the sleeve 51A in an axial direction thereof.

Therefore, each developing device 5B makes it possible to further suppress uneven development density in axial directions of the developing rollers 51 and 52 of each developing device 5B. Moreover, in each developing device 5B, the interval α between the first developing roller 51 and the photoconductor drum 21 need not be set relatively small. Further, costs are not increased by setting a collecting guiding plate 58. Therefore, the developing device 5B is a desirable device also from this point.

### Other Exemplary Embodiments

In the first and second exemplary embodiments, according to the developing devices 5 and 5B to which the invention is applied, it is possible to set the directions of rotations of the sleeves 51A and 52A of the respective developing rollers 51 and 52 in different directions in relation to the direction of rotation of the photoconductor drum 21.

As long as the developing devices 5 (5B) are usable, for example, the type of the image forming apparatus 1 using the developing devices 5 (5B) according to the invention is not particularly limited. Accordingly, the image forming apparatus may be formed as an image forming apparatus having a publicly known existing structure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a first developer transporting member that has a circular cylindrical shape, the first developer transporting member being provided so as to rotate with the first developer transporting member being spaced apart by a required interval from an outer peripheral surface of a latent image carrying member that rotates, the first developer transporting member having an outer peripheral surface that transports a magnetic developer;
a first magnet member that is provided in a fixed state in an internal space of the first developer transporting member, the first magnet member including a plurality of magnetic poles that extend along an axial direction of the first developer transporting member and that are disposed so as to be spaced apart from each other in a direction of rotation of the first developer transporting member;
a second developer transporting member that has a circular cylindrical shape, the second developer transporting member being provided so as to rotate with the second developer transporting member being spaced apart by a required interval from a portion of the outer peripheral surface of the latent image carrying member that is situated downstream from the first developer transporting member in a direction of rotation of the latent image carrying member and with the second developer transporting member being spaced apart by a required interval from the outer peripheral surface of the first developer transporting member, the second developer transporting member having an outer peripheral surface that transports a magnetic developer;
a second magnet member that is provided in a fixed state in an internal space of the second developer transporting member, the second magnet member including a plurality of magnetic poles that extend along an axial direction of the second developer transporting member and that are disposed so as to be spaced apart from each other in a direction of rotation of the second developer transporting member; and
a passage regulating member that is provided with the passage regulating member opposing the outer peripheral surface of one of the first developer transporting member and the second developer transporting member along the axial direction of the one of the first developer transporting member and the second developer transporting member and with the passage regulating member being spaced apart by a required interval from the outer peripheral surface of the one of the first developer transporting member and the second developer transporting member, the passage regulating member regulating passage of a portion of the developer supplied to the outer peripheral surface of the one of the first developer transporting member and the second developer transporting member, and maintaining a required transport amount,
wherein, among the plurality of magnetic poles of the first magnet member and the plurality of magnetic poles of the second magnet member, the magnetic poles having different magnetic properties that are disposed closest to each other and that oppose each other are disposed in an area that is opposite an area at whose side the latent image carrying member exists with a virtual straight line being a boundary thereof, the virtual straight connecting a center position of the first magnet member corresponding to a center of rotation of the first developer transporting member and a center position of the second magnet member corresponding to a center of rotation of the second developer transporting member with each other.

2. The developing device according to claim 1, wherein a collecting guiding member that is disposed close to the outer peripheral surface of one of the first developer transporting member and the second developer transporting member at whose side the passage restricting member does not exist, that receives developer that is separated after the developer passes a development position opposing the latent image carrying member, and that guides and transports the received developer to a required portion is not provided.

3. An image forming apparatus comprising:
the latent image carrying member that rotates; and
the developing device according to claim 1 that supplies developer to the latent image carrying member and that develops a latent image.

4. An image forming apparatus comprising:
the latent image carrying member that rotates; and
the developing device according to claim 2 that supplies developer to the latent image carrying member and that develops a latent image.
